(19) United States
(12) Patent Application Publication
(10) Pub. No.: US 2008/0232038 A1
(43) Pub. Date: Sep. 25, 2008

(54) Method For Electrophoretic Deposition Of Conductive Polymer Into Porous Solid Anodes For Electrolyte Capacitor

(75) Inventors: Nissim Cohen, Kiryat Tivon (IL); Assaf Thon, Haifa (IL); Martin Zarbov, Hadera (IL)

Correspondence Address: MARSTELLER & ASSOCIATES, P O BOX 803302, DALLAS, TX, 75380-3302, US

(73) Assignee: CEREL (CERAMIC TECHNOLOGIES) LTD., Tirat Hacarmel (IL)

(21) Appl. No.: 12/065,271

(22) PCT Filed: Sep. 4, 2005
(86) PCT No.: PCT/IL2006/001015

§ 371 Date: May 28, 2008

(30) Foreign Application Priority Data
Sep. 4, 2005 (IL) 170659

(51) Int. Cl. H01G 9/028; C25D 13/06

(52) U.S. Cl. 361/532; 204/471; 204/489

(57) ABSTRACT

The invention discloses a method for forming a conductive polymer with an electrophoretic deposition cell, into porous anode for electrolytic capacitors. The conductive polymer is directly deposited on the oxide layer of the anode body. The electrolytic polymerized conductive polymer material form the cathode in solid electrolyte capacitors. The method allows low ESR capacitors to be produced. The invention provides a high yield and low cost industrial process with efficient materials utilization. The present invention successfully deposits particles from dispersion on continuous, highly insulating dielectric layers using electrophoretic deposition by use of EPD voltage near or above the anode dielectric formation voltage, where the anode body is positively biased relative to the EPD counter electrode, thereby allowing a current to be driven through the dielectric layer.

### FIELD OF THE INVENTION

This invention relates to the field of solid electrolyte capacitors. More specifically, this invention relates to an electrical field-enhanced method for conductive polymer impregnation into porous anodes in order to form the cathode in solid electrolyte capacitors.

### BACKGROUND OF THE INVENTION

Solid electrolytic capacitors, available with various forms of encapsulation, feature higher electrical capacitance in package sizes which are small when compared to other types of capacitors. Due to their high volumetric efficiency and reliability, miniature ‘chip’ solid electrolytic capacitors are especially suitable for surface mounting technology (SMT) applications and are increasingly being used in current microelectronics and communication applications.

A solid electrolytic capacitor consists of an anode, which is a high surface area, porous sintered pellet made from capacitor grade powders with an embedded or attached wire or foil conductor covered by a dielectric oxide layer, which is usually formed by anodizing the anode open-pore surface. The dielectric layer follows closely the contour of the open porosity in the sintered body. The anodized porous body, i.e. the capacitor anode, is then impregnated with a cathodic electrically conducting material, connected to a cathode lead wire or frame and then encapsulated in a suitable potting compound such as epoxy or other resin. The high open porosity surface area of the pellet is the dominant feature that allows the solid electrolytic capacitor to have better volumetric efficiency than any other type of capacitor. An example of a solid electrolytic capacitor 10 known in the art is shown in FIG. 1A. FIGS. 1B and 1C are cross-sectional views taken respectively along lines A-A and B-B in FIG. 1A. In FIGS. 1B and 1C can be seen the anode 12, the anode wire 14, the lead frame for the cathode 16 and the encapsulation layer 18. FIG. 1D is an enlargement of area 20 in FIG. 1C. In FIG. 1D are seen the interface 22 between the anode material and the MnO₂, the MnO₂ layer 24, the graphite layer 26, and the silver bearing layer 28, all covered by encapsulation layer 18.

Anodes of solid electrolyte capacitors made from the valve metals tantalum (Ta), niobium (Nb), aluminum (Al) and niobium oxide (NbO) dominate today's market.

Methods for forming capacitor anodes are well known in the art and include both mechanical pressing and electrophoretic deposition (EPD). Electrophoretic deposition processes are described in International Patent Applications WO 02/103728 and WO 2006/027767 both by the same applicant, the descriptions of which, including references cited therein, are incorporated herein by reference in their entirety.

In the prior art methods a cathode is formed on the free surface of the dielectric film by impregnation of a suitable cathode material, such as manganese dioxide (MnO₂), or a conductive polymer. The cathode material should conform closely to the surface micro-topology of the convoluted oxide layer that is formed on the interconnected internal pore surface.

External connections for the capacitor cathode are made through thin conductive layers, typically formed from graphite and silver, applied by methods well known in the art.

Conductive polymers have an electrical conductivity that can be over 1000 times higher than the conductivity of MnO₂, which is commonly used as the cathode material in conventional solid electrolyte capacitors. Therefore, cathodes made of conductive polymers are considered essential for low equivalent series resistance (ESR) solid electrolyte capacitors. There are two methods known in the art for impregnation of anodes with conductive polymers. Both are based on multi-step immersion in solution of monomer precursors and oxidizers for an in situ surface chemical polymerization process. Details can be found in: “PEDT as Conductive Polymer Cathode in Electrolytic Capacitors” Udo Merker, Ynud Reuter, Klaus Wussow, and Stephan Kirchmeyer, H. C. Starck GmbH and Ursula Tracht Bayer A G, presented to CARTS 2002. The monomer and oxidizer can be brought into the porous structure either sequentially or as a premixed solution. In the sequential process, the anode pellet is first dipped into an oxidizer solution, then the solvent is evaporated and the pellet is dipped into the monomer solution. After polymerization residual materials are washed out to open the pore structure for the next cycle. The major disadvantages of the sequential process are that for every cycle, two dips are necessary and the monomer and oxidizer cannot really be applied in a stoichiometric ratio.

For the premixed solution, process monomer and oxidizer are mixed in a solvent in a stoichiometric ratio. Then the anode pellet is dipped into the solution and dried. The advantages of this process are the use of stoichiometric mixtures and that only one dip is necessary for each cycle. Furthermore, conductive films made with premixed solutions have a much better quality and a higher conductivity than those made by sequential dipping. However, the thickness of conductive polymer layers that are achievable using current methods is limited to about twenty nanometers. This low cross-sectional area for electrical conduction increases the resistance of the cathode.

Examples of the use of polymers as electrically conducting solid cathodes are given in U.S. Pat. No. 6,519,137, U.S. Pat. No. 6,451,074, U.S. Pat. No. 6,391,379, and U.S. Pat. No. 6,361,572.

Although dispersions of conductive polymer particles in water or solvent are commercially available (for example, Baytron PH from H.C. Starck GmbH, a PEDT/PSS dispersion in water), the tendency to inhomogeneous, non-uniform and discontinuous surface coverage of the dielectric layer within the anode pores does not allow easy or effective impregnation of a porous anode pellet by simple dipping of the anode in such dispersions.

An example of commercially available materials for the preparation of premixed solutions is Baytron M (EDT), which is mixed with Baytron CE, both manufactured by H.C. Starck GmbH, Germany. Baytron M, consisting of 3,4-ethylenedioxythiophene (EDT; CAS number 126213-50-1), is a monomer for the production of PEDT conductive polymer coatings. Baytron CE is a 40% ethanolic solution of iron (III)p-toluolenesulfonate, an oxidizing agent based upon an iron(III) salt. One part by weight of Baytron. M is mixed with 20 parts of Baytron CE, providing a reactive mixture in a stoichiometric ratio of 2 mole iron (III) p-toluolenesulfonate per mole EDT. Three dips, dry and wash cycles are required to achieve full impregnation when using premixed solutions, where each cycle requires at least 30 minutes.

As already stated, cathodes of solid electrolytic capacitors like tantalum, niobium and niobium oxide are manufactured in accordance with the prior art by impregnation of the anode with a suitable material such as manganese dioxide (MnO₂) or a conductive polymer. The method known in the art for impregnation of anodes with conductive polymers is immersion in monomer precursors for an in situ surface chemical polymerization process, where use of premixed solutions of the monomer and oxidizer is the generally preferred process.

Both the manganese dioxide process and the prior art conductive polymer process require multiple process cycles for implementation. Furthermore, the conductive polymer premix solutions result in waste due to short pot life. Also, the achieved conductive polymer coating from solution is very thin, only about 20 nm, limiting the potential reduction in capacitor ESR.

The limitations of conductive polymer could be overcome if it were possible to use fully polymerized conductive polymer as the cathode material instead of in-situ polymerization from monomer and oxidizer solutions. Although dispersions of conductive polymer particles in water or solvent are commercially available, lack of an efficient impregnation process does not allow impregnation of a porous tantalum anode pellet by dipping of the anode in such dispersions.

An object of the current invention is to provide a new and improved method to apply electrically conductive polymer films to the convoluted dielectric free surface of a solid electrolyte capacitor porous anode.

It is another objective of the current invention to provide a means to partially or fully impregnate highly conductive and viscous polymers into an open pore structure of sub-micron pores in the porous anode of a solid electrolyte capacitor.

Yet another objective of the current invention is to provide a method to apply a uniform polymer coating of controlled thickness on the external dielectric surface of solid electrolyte capacitor anodes.

Another objective of the current invention is to provide electric-field-enhanced methods to impregnate conductive polymer materials on convoluted dielectric surfaces.

Another objective of the current invention is to minimize the number of sequential steps required for impregnation of the cathode material and the time required for conducting each step.

Another objective of the current invention is to maximize utilization and minimize waste of the conducting polymer impregnation material.

Still another objective of the current invention it to provide an impregnation process that is suitable for use at room temperature.

Another objective of the current invention is to enhance control of the thickness, density, and uniformity of the conductive film applied as the cathode to the convoluted surface of the dielectric.

Another objective of the current invention is to preserve the mechanical, physical, chemical, and electrical properties of the dielectric layer on the convoluted internal surfaces of the open porosity of the anode and avoid any degradation of these properties.

Another objective of the current invention is to provide a solid electrolytic capacitor of any size having low ESR.

Yet another objective of the method of the invention is to provide for a high yield and low cost industrial process for the impregnation of a conducting polymer to form the cathode contact in the porous structure of an electrolytic capacitor.

Other objects and advantages of the invention will become apparent in the following description of this invention.

### SUMMARY OF THE INVENTION

As opposed to the prior art methods, the method of the present invention uses electrophoretic deposition (EPD) to impregnate the anode with fully polymerized conductive polymer material from dispersions.

The invention described herein provides for a high yield and low cost industrial process with efficient materials utilization for the impregnation of conducting polymers to form the cathode contact in the porous structure of an electrolytic capacitor. The invention furthermore exploits high conductivity polymers and deposits these in relatively thick layers within the anode pores and onto the outer surface of the anode, allowing lower ESR capacitors to be produced.

In a first aspect the present invention is a method for forming a conductive polymer cathode for a solid electrolyte capacitor, the method comprising:
(a) immersing the dielectric coated anode body of a solid electrolyte capacitor in an electrophoretic deposition (EPD) cell containing a dispersion of particles of the conductive polymer in a liquid; and
(b) using a power supply to apply a voltage between the anode body and a counter electrode, thereby forming a current that deposits a continuous conductive polymer cathode layer on the free surface of the dielectric.

The voltage applied in the EPD cell can have a value that is slightly less than, equal to, or greater than the dielectric formation voltage. The voltage can be kept constant and the EPD current controlled at the power supply or the EPD cell current can be held constant. The constant EPD current can be in the range of 0.01 mA to 0.5 mA per mg of anode mass.

According to the method of the invention, the conductive polymer can coat the convoluted dielectric free surface of the pore structure within the solid electrolytic capacitor anode, the outer surface of the dielectric coated anode can be coated with conductive polymer during the EPD process of forming the cathode from the conductive polymer on the convoluted dielectric free surface of the pore structure within the solid electrolytic capacitor anode, and the EPD process can be used to coat with conductive polymer the outer surface of an anode previously impregnated with cathode material. The previously impregnated cathode material can be manganese dioxide, conductive polymer produced by in situ chemical polymerization, or conductive polymer deposited with EPD from a conductive polymer dispersion. Preferably the thickness of the external conductive polymer coating is at least 1 micrometer.

The conductive polymer can be any conductive polymer material that can be dispersed as particles in a liquid wherein the particles and the dispersion have characteristics that allow EPD to be performed. In preferred embodiments of the invention the conductive polymer material is chosen from the group comprising: polythiophene or derivatives thereof, polyaniline or derivatives thereof, and polypyrole or derivatives thereof.

The conductive polymer used to coat the convoluted dielectric free surface of the pore structure within the solid electrolytic capacitor anode should have a maximum electrical conductivity, at least higher than 30 S/cm. The conductive polymer used to coat the outer surface of an anode previously impregnated with cathode material should have a maximum electrical conductivity, at least higher than 50 S/cm.

The dispersion should have the following characteristics: concentration of the particles in the dispersion in the range of 1.5% to 10% by weight, viscosity in the range of 5 cP to 70 cP, Zeta potential lower than −30 mV, pH in the range of 1 to 3, and conductivity greater than 50 S/cm.

In order to coat the convoluted dielectric free surface of the pore structure within the solid electrolytic capacitor anode, the mean size of the particles in the dispersion should be smaller than the mean pore size within the anode. In order to coat with conductive polymer the outer surface of an anode previously impregnated with cathode material, the mean particle size in the dispersion should be smaller than 10 micrometers.

In another aspect, the invention is a solid electrolytic capacitor comprising a cathode made from a conductive polymer layer formed by an EPD process on the free surface of the dielectric coating of an anode body.

### BRIEF DESCRIPTION OF THE FIGURES

FIG. 1A shows a prior art solid electrolytic capacitor;

FIG. 1B and FIG. 1C are low magnification sectional views of the capacitor of FIG. 1A;

FIG. 1D is an enlarged view of an area shown in FIG. 1C;

FIG. 2 is a schematic view of an electrophoretic deposition cell (EPD);

FIGS. 3A and 3B are SEM micrographs of a partially sintered solid electrolyte capacitor anode, which has been sectioned after simple immersion in a conductive polymer dispersion; and

FIG. 4A, FIG. 4B, and FIG. 5 are SEM micrographs of partially sintered solid electrolyte capacitor anodes, which have been sectioned after immersion in conductive polymer dispersion and applying an electric field to promote electrophoretic deposition.

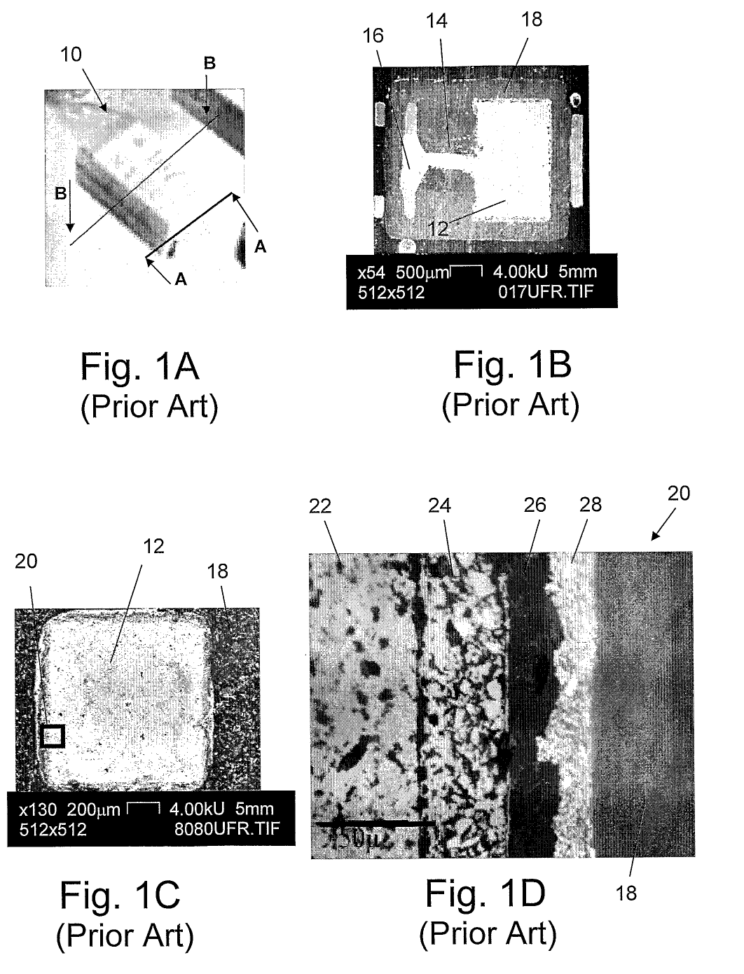

### DETAILED DESCRIPTION OF THE PREFERRED EMBODIMENT

As is well known, EPD is carried out by applying a voltage between two electrodes immersed in a suitable dispersion. Persons familiar with the present state of the art would know that, if one of the electrodes is a substrate coated with a continuous dielectric layer, then current will not be able to flow between the electrodes and EPD deposition on the dielectric layer could not take place. In other words, EPD as it is presently applied cannot be used to form a conductive polymer layer within the open pore structure of a capacitor anode from a dispersion of the conductive polymer.

As opposed to the prior art methods of electrophoretic deposition, the present invention successfully deposits particles from dispersion on continuous, highly insulating dielectric layers. This invention enables electrophoretic deposition by use of EPD voltage near or above the anode dielectric formation voltage, where the anode body is positively biased relative to the EPD counter electrode. These high voltages allow a current to be driven through the dielectric layer. The conductive polymer dispersions are chosen such that the dispersed particles are negatively charged and therefore deposit within the pores and onto the outer surface of the positively biased anode.

This invention uses a positive bias on the anode body for EPD of the cathode material since a negative bias would electrochemically dissolve the dielectric layer. The high positive EPD bias that is used by the invention would also be expected to damage the dielectric, but this is prevented in the invention by limiting the deposition to times as short as 1 second or by the use of constant current power supplies that prevent catastrophic dielectric breakdown or both.

In the present invention, a constant EPD voltage having a value ranging from slightly below to higher than the dielectric formation voltage is applied for a short time, generating a current, which is limited at the power supply, through the anode dielectric. More preferably, the current is held to a constant value and the voltage is capped at a slightly lower, equal, or higher voltage than the dielectric formation voltage. It has been found that under these conditions conducting polymers meeting certain requirements, which will be detailed hereinbelow, can be uniformly deposited onto the dielectric surface throughout the anode pore structure.

The starting point of all embodiments of the invention is a porous solid electrolyte capacitor anode made by any prior art method including an EDP process as described in the above referenced international patent applications.

In a first preferred embodiment, The cathode is made by impregnating the anode with the conductive polymer. The preferred characteristics of the conductive polymer and of the EDP dispersion for the purpose of impregnating the anode, i.e., for penetrating the open pore structure of the capacitor anode to create a continuous conducting cathode on the dielectric surface of the open pore structure, are:

The conductive polymer has maximum electrical conductivity, at least higher than 30 S/cm.

The mean particle size of the conductive polymer in the dispersion is smaller than the mean pore size of the anode body.

The conductive polymer has thermal stability up to 260° C. for short exposure times, i.e., up to one minute, and thermal stability up to 175° C. for an exposure time of one hour.
The conductive polymer has stable conductivity over time, e.g., the conductivity decreases no more than 50% after 1000 hours at 125° C.
The dispersion is chemically inert, i.e., it is non-reactive with respect to the dielectric free surfaces, with the anode material, with the conductive carbon overcoat layer, with the capacitor encapsulation material, or with residual moisture and oxygen that may diffuse through the encapsulation material.
The dispersion solid concentration is in the range of 1.5% to 10% by weight.
The viscosity of the dispersion is in the range of 5 to 70 cP.
The zeta potential of the dispersion is lower than −30 mV.
The pH of the dispersion is in the range of 1 to 3.
The conductivity of the dispersion is preferably greater than 50 S/cm.

In a second preferred embodiment, the electrophoretic impregnation process is used to produce an outer conductive polymer coating on the surface of the cathode impregnated anode, after which conductive carbon and silver coatings known in the art may be directly deposited onto said conductive polymer coating. The preferred characteristics of the conductive polymer and of the EDP dispersion for the purpose of coating the outer surface of the capacitor anode are:
The conductive polymer has an electrical conductivity higher than 50 S/cm
The mean particle size of the conductive polymer in the dispersion is smaller than 10 microns.
The conductive polymer has thermal stability up to 260° C. for short exposure times, e.g. up to one minute, and thermal stability up to 175° C. for an exposure time of one hour.
The conductive polymer has stable conductivity over time, i.e. the conductivity decreases no more than 50% after 1000 hours at 125° C.
The dispersion is chemically inert, i.e. it is non-reactive with respect to the dielectric free surfaces, with the anode material, with the conductive carbon overcoat layer, with the capacitor encapsulation material, or with residual moisture and oxygen that may diffuse through the encapsulation material.
The dispersion solid concentration is in the range of 1.5% to 10% by weight.
The dispersion viscosity is in the range of 5 to 70 cP.
The dispersion Zeta potential is lower than −30 mV.
The pH of the dispersion is in the range of 1 to 3.
The conductivity of the dispersion is greater than 50 S/cm.

For both of the preferred embodiments, the conductive polymer is selected from a group of materials that satisfies the above conditions and includes, for example, polythiophene and derivatives thereof, polyaniline and derivatives thereof and polypyroles, and derivatives thereof.

The group of suitable polythiophenes includes, for example, polyethylenedioxithiophene (PEDT), commercially available as Baytron PH, which comprises PEDT, an acid, and a matrix of polystyrene.

Conductive polymers from the group containing polythiophenes can be dispersed in liquids such as water and alcohols, e.g. ethanol. The concentration of said conductive polymer from said group of polythiopenes is preferably between 1.5% and 10% by weight.

The group of polypyrole derivatives can include polypyrole doped with acid. The conductive polymer from the group comprising polypyroles can be dispersed in a group of liquids including, for example, water, xylene, and alcohols, e.g. ethanol and isopropyl alcohol (IPA). The concentration of said conductive polymer from said group of polypyroles in the dispersion is preferably between 1.5% and 10% by weight.

A typical representative of the group of conductive polyaniline derivatives is polyaniline para-tolouene sulfonic acid (PTSA) commercially available dispersed at various concentrations in water from Ormecon (Germany) under the PANI brand name.

The conductive polymer from the group containing polyaniline can be dispersed in a group of liquids comprising, but not limited to, water, xylene, and alcohols, e.g. ethanol. The concentration of conductive polymer from the group of polyaniline in the dispersion is preferably between 1.5% and 10% by weight.

The characteristics of two of the formulations available from Ormecon, designated 6903-103-001 and and 6903-104-002 are listed in the following table.

| | | |
|---|---|---|
| Batch number | 6903-103-001 Lot2 | 6903-104-002 Lot 1 |
| Date of preparation | March 2005 | June 2005 |
| Form | Dispersion | Dispersion |
| Solvent | Water | Water |
| Color | Green | Green |
| pH | 1.3 | 1.8 |
| Concentration (solid | 2.1 | 1.4 |
| contents in weight %) | | |
| Viscosity at 20° C. | 6 cP | 62 cP |
| Particle size Mean number | 75 nm | 63 nm |
| (Mn) | | |
| 90% of particles < given | 122 nm | unavailable |
| value | | |
| Conductivity of spin | 60 S/cm in vacuum | 167 S/cm in vacuum |
| coated film on glass | | |
| substrate | | |

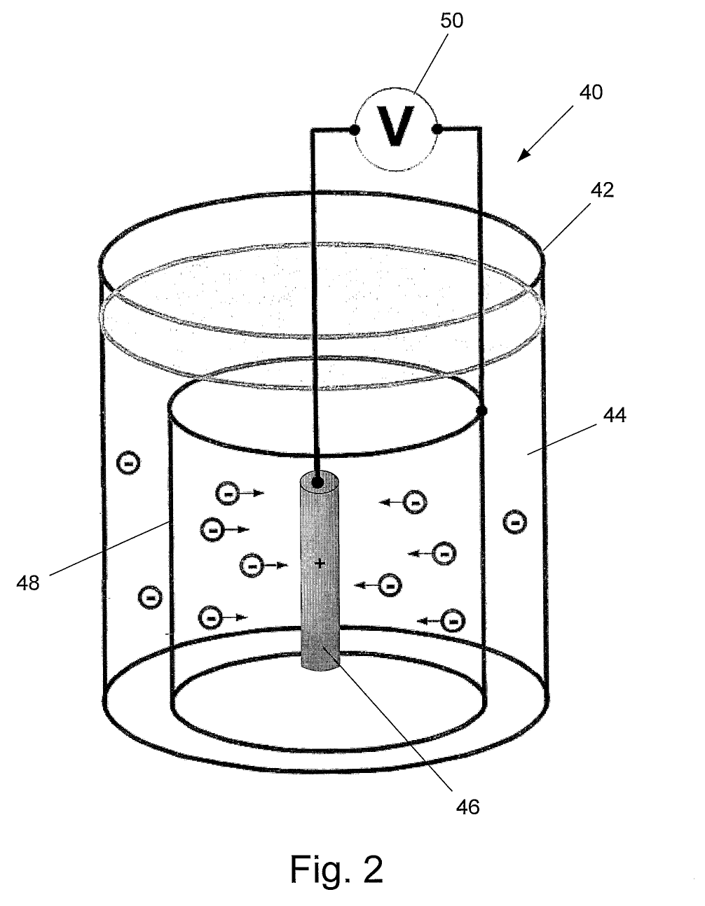

FIG. 2 schematically shows an EPD cell for carrying out the invention. The EPD cell 40 is comprised of a container 42, which is filled with dispersion 44 comprised of particles of the conductive polymer dispersed in a suitable liquid as described herein, and an electric circuit. The electric circuit is made up of a power supply 50 and two electrodes, a counter electrode 48 and the capacitor anode 46 on which the conductive polymer particles are deposited. As shown schematically in the figure, conductive polymer particles migrate along the lines of the electrical field formed by the potential applied between the anode 46 and the counter electrode 48 in the polymer dispersion and impregnate the porous anode body, depositing on the dielectric free surface to form a layer of conductive polymer of high integrity.

In the first embodiment, i.e. impregnation of the open pore structure of the dielectric layer of the anode with conductive polymer, the temperature of the dispersion of conductive polymer during immersion is kept between SoC and 80° C. and the anode is immersed for a period of time ranging from 1 second to 30 minutes.

The process can be carried out at constant current in the range of 0.01 mA to 0.5 mA per mg anode mass, in which case the voltage will rise from slightly below or equal to the dielectric formation voltage to a limit which is set by the operator. The process can also be carried out at constant voltage as discussed hereinabove, in which case the current must be capped to prevent it from rising to the level that will destroy the dielectric coating. The electrophoretic impregnation process, if carried out long enough will simultaneously produce an outer conductive polymer coating on the surface of the anode, after which conductive carbon and silver coatings known in the art may be directly deposited onto the outer conductive polymer coating.

In the second embodiment referred to above a thick outer conductive polymer coating may be formed with any cathode material either polymer or inorganic by EPD on an anode previously impregnated by any of the methods known in the art or by EPD in accordance with the first embodiment of this invention.

In one embodiment of the coating process, the temperature of the emulsion of conductive polymer during immersion of the anode in the EDP cell is between 5° C. and 50° C. and the anode is immersed for a period of time ranging from 1 second to 30 minutes.

As in the case of impregnating the inner pore structure of the anode, the process can be carried out at constant current in the range of 0.01 mA to 0.5 mA per mg anode mass, in which case the voltage will rise from slightly below or equal to the dielectric formation voltage to a limit which is set by the operator. The process can also be carried out at constant voltage, in which case the current must be capped to prevent it from rising to the level that will destroy the dielectric coating.

As mentioned hereinabove, in different embodiments the outer conductive polymer coating can be applied using EPD onto an anode that was previously impregnated with conductive polymer cathode using EPD, that was previously impregnated with conductive polymer cathode using an in situ surface chemical polymerization process, or that was previously impregnated with manganese dioxide cathode using known dipping and pyrolysis processes. The preferred thickness of the outer conductive polymer coating formed by EPD is at least 1 micrometer.

External electrical connections for the cathode, which comprise a first conductive carbon layer and second silver layer, are applied after formation of the outer protective layer by methods well known in the art.

The following examples are provided merely to illustrate the invention and are not intended to limit the scope of the invention in any manner.

### EXAMPLE 1

### Conductive Polymer Dispersion—Dipping

A dielectric layer was formed by methods known in the art on the convoluted, open pore free surface of a NbO pellet that had been formed by electrophoretic deposition on a tantalum wire anode of 200 microns diameter and partially sintered in vacuum at 1200° C. The porous pellet was then immersed for 5 minutes in a solution of 100% Ormecon D1027 B50 PEDT dispersion, batch number 1027B50-00-50-050209-1 (manufactured by Ormecon GmbH, Germany). Mean Particle Size Distribution of this dispersion is 245 nm and conductivity is 54 S/cm. After dipping, the anode was dried in an oven at 100° C., washed in deionized water, and dried.

After the dipping and drying process, outer coatings of conductive carbon and silver were applied to the anode, providing electrical contact to the impregnated cathode for measurements. The outer coating process, which is well known in the art, was performed as follows:

1) Dip in Aquadag E carbon paste. The Aquadag E was diluted with deionized water before dipping: one part by weight Aquadag E to 4 parts DI water. The coating was allowed to dry for 30 minutes at room temperature. A standard cure was then performed in an oven by ramping at 5° C./minute to 100° C., holding for 30 minutes, and then cooling at 10° C./minute to room temperature.

2) Dip in 5262L polymeric Ag paste (manufactured by DuPont). The coating was allowed to dry for 20 minutes at room temperature. A standard cure was then performed in an oven by ramping at 5° C./minute to 80° C., holding for 15 minutes, further ramping at 5° C./minute to 175° C., holding for 60 minutes, and then cooling at 10° C./minute to room temperature.

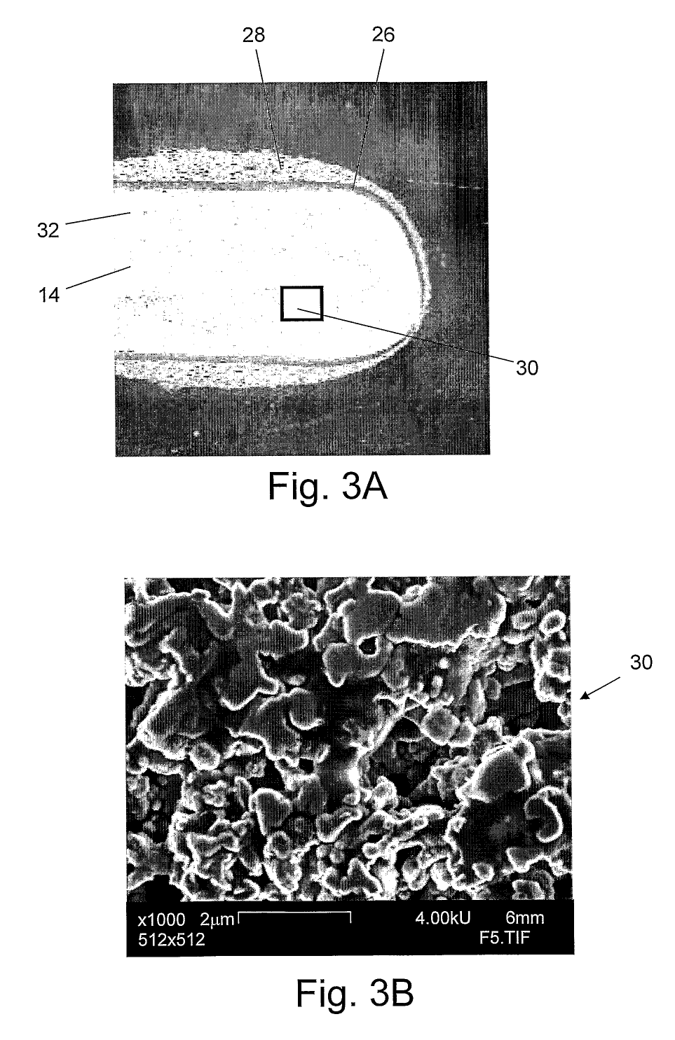

FIG. 3A is a ×56 SEM micrograph of a cross-section of the capacitor assembly produced according to the method just described. In the figure can be seen, tantalum wire 14; the anode 32, after being dipped in the conductive polymer emulsion; the carbon layer 26; and the outer coating of silver 28. FIG. 3B is a ×10000 SEM micrograph showing area 30 of the capacitor assembly shown in FIG. 3A. The pores in the anode structure are the black regions and the fact that most of the pores have such very sharply defined edges and a uniform deep black color indicates that conductive polymer has hardly penetrated into them. Another indication that the cathode material has hardly impregnated the anode is that the measured capacitance of the finished capacitor was only 0.2 μF.

### EXAMPLE 2

### Conductive Polymer Dispersion—Dipping

A dielectric layer was formed by methods known in the art on the convoluted, open pore free surfaces of five NbO pellets that had been formed by electrophoretic deposition on a tantalum wire anode of 200 microns diameter and partially sintered in vacuum at 1200° C. The porous pellets were then immersed for 3 minutes in a solution of 100% Ormecon 6903-103-001 Lot 2 polyaniline (PANI) dispersion, manufactured by Ormecon GmbH, Germany. Mean Particle Size of this dispersion is 75 nm and conductivity is 60 S/cm. After dipping, the anodes were dried in an oven at 100° C., washed in deionized water and dried.

After the dipping and drying process, outer coatings of conductive carbon and silver were applied to the anodes using the same process described in Example 1, providing electrical contact to the impregnated cathode for measurements.

The measured capacitance of the five finished capacitors was 0.005 μF, 0.25 μF, 0.26 μF, 0.002 μF and 0.135 μF.

### EXAMPLE 3

### Conductive Polymer Dispersion—Impregnation by EPD

A dielectric layer was formed by methods known in the art on the convoluted, open pore free surface of a NbO pellet made by electrophoretic deposition on a 200 microns diameter tantalum wire and partially sintered in vacuum at 1200° C. Dielectric formation voltage was 20V.

The pellet was then immersed in an EPD cell containing an Ormecon 6903-103-001 Lot 2 polyaniline (PANI) dispersion, manufactured by Ormecon GmbH, Germany. Mean Particle Size of this dispersion is 75 nm and conductivity is 60 S/cm. During immersion, an external voltage of 29 volts was applied for 2 seconds between the sintered pellet, the anode, and a cathode counter-electrode. Negatively charged PANI particles were deposited on the dielectric free surface of the convoluted, interconnected open pore structure.

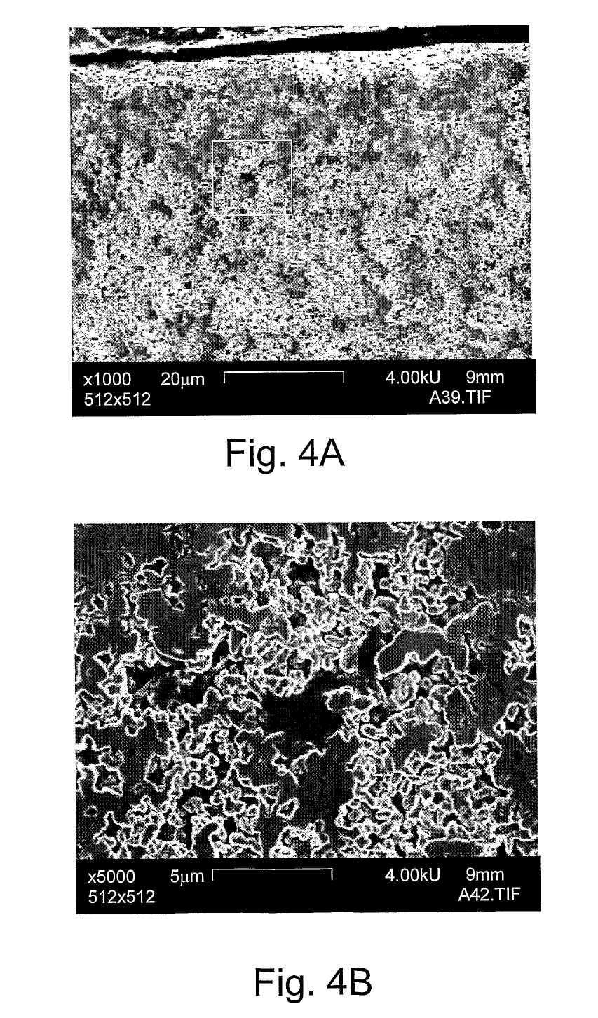

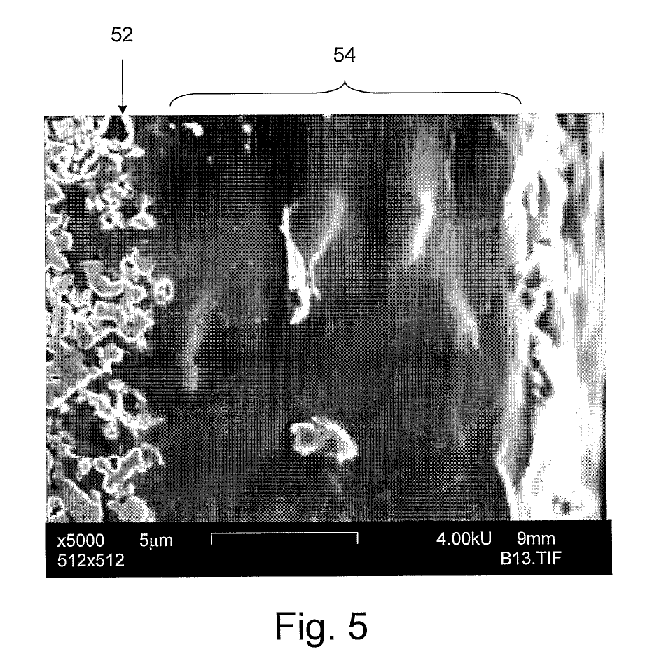

FIG. 4A is a SEM micrograph showing a cross-section of the anode structure of this example at a magnification of ×1000. FIG. 4B is a ×5000 magnification of the area inside the outlined square in FIG. 4A. The cloudy grey coloring inside the pores and their fuzzy edges is evidence that under these process conditions the PANI impregnated the anode porous body and was deposited on the dielectric free surface of the porous anode.

### EXAMPLE 4

### Conductive Polymer Dispersion—Formation of the Outer Conductive Polymer Coating by EPD

The pellet prepared in Example 3 was then immersed for a further 5 seconds in an EPD cell containing a dispersion of Ormecon 6903-103-001 Lot 2. During the 5 seconds immersion time, an external voltage of 30 volts was applied between the sintered pellet, i.e. the anode, and a cathode counter-electrode. Negatively charged PANI particles were again deposited on the dielectric surface. The pellet was then dried.

Referring to FIG. 5, it can be seen that under these process conditions the Ormecon 6903-103-001 PANI deposited on the external surface 52 of the porous anode body to form a thick outer polymer coating 54.

### EXAMPLE 5

### Conductive Polymer Dispersion—Impregnation by EPD

A dielectric layer was formed by methods known in the art on the convoluted, open pore free surface of a NbO pellet made by electrophoretic deposition on a 200 microns diameter tantalum wire and partially sintered in vacuum at 1200° C. Dielectric formation voltage was 20V.

The pellet was then immersed for 2 seconds in an EPD cell containing a 100% Ormecon D1027 B50 PEDT dispersion, batch number 1027B50-00-50-050209-1 (manufactured by Ormecon GmbH, Germany). Mean Particle Size of this dispersion is 245 nm and conductivity is 54 S/cm.

During the 2 seconds immersion time an external voltage of 29 volts was applied between the sintered pellet, the anode, and a cathode counter-electrode. Negatively charged PEDT particles were deposited on dielectric surfaces of the convoluted, interconnected open pore structure. The anode was then dried in an oven at 100° C., washed in deionized water and dried.

After EPD impregnation of the anode with conductive polymer, outer coatings of conductive carbon and silver were applied using the same process described in Example 1, providing electrical contact to the cathode for measurements.

Capacitance of the capacitor was then measured and found to be 1.03 μF.

### EXAMPLE 6

### Conductive Polymer Dispersion—Impregnation by EPD

A dielectric layer was formed by methods known in the art on the convoluted, open pore free surface of a NbO pellet made by electrophoretic deposition on a 200 microns diameter tantalum wire and partially sintered in vacuum at 1200° C. Dielectric formation voltage was 20V.

The pellet was then immersed for 2 seconds in an EPD cell containing a 100% Ormecon 6903-104-002 Lot 1 PANI dispersion (manufactured by Ormecon GmbH, Germany). Mean Particle Size of this dispersion is 63 nm and conductivity is 167 S/cm.

During the 2 seconds immersion time an external voltage of 29 volts was applied between the sintered pellet, the anode, and a cathode counter-electrode. Negatively charged PANI particles were deposited on dielectric surfaces of the convoluted, interconnected open pore structure. The anode was then dried in an oven at 100° C., washed in deionized water and dried.

After EPD impregnation of the anode with conductive polymer, outer coatings of conductive carbon and silver were applied using the same process described in Example 1, providing electrical contact to the cathode for measurements.

Capacitance of the capacitor was then measured and found to be 0.82 μF. ESR was measured to be 2 ohms.

### EXAMPLE 7

### Conductive Polymer Dispersion—Impregnation by EPD

A dielectric layer was formed by methods known in the art on the convoluted, open pore free surface of a NbO pellet made by electrophoretic deposition on a 200 microns diameter tantalum wire and partially sintered in vacuum at 1200° C. Dielectric formation voltage was 21V.

The pellet was then immersed for 1 minute in an EDP cell containing a 100% Ormecon 6903-103-001 Lot 2 PANI dispersion (manufactured by Ormecon GmbH, Germany). Mean Particle Size of this dispersion is 75 nm and conductivity is 60 S/cm.

During the 1 minute immersion time a constant current of 0.1 mA was applied to the sintered pellet, the anode, from a cathode counter-electrode. Voltage was limited to 21 volts in order not to exceed the original formation voltage. Negatively charged PANI particles were deposited on dielectric surfaces of the convoluted, interconnected open pore structure. The anode was then dried in an oven at 100° C., washed in deionized water and dried.

After EPD impregnation of the anode with conductive polymer, outer coatings of conductive carbon and silver were applied using the same process described in Example 1, providing electrical contact to the cathode for measurements.

Capacitance of the capacitor was then measured and found to be 1.7 μF. ESR was measured to be 3 ohms. Current leakage with an applied DC voltage of 6.8V was measured to be 0.04 μA.

### EXAMPLE 8

### Conductive Polymer Dispersion—Impregnation by EPD

A dielectric layer was formed by methods known in the art on the convoluted, open pore free surface of a NbO pellet made by electrophoretic deposition on a 200 microns diameter tantalum wire and partially sintered in vacuum at 1200° C. Dielectric formation voltage was 21V.

The pellet was then immersed for 1 minute in an EPD cell containing a 100% Ormecon 6903-104-002 Lot 1 PANI dispersion (manufactured by Ormecon GmbH, Germany). Mean Particle Size of this dispersion is 63 nm and conductivity is 167 S/cm.

During the 1 minute immersion time a constant current of 0.1 mA was applied to the sintered pellet, the anode, from a cathode counter-electrode. Voltage was limited to 21 volts in order not to exceed the original formation voltage. Negatively charged PANI particles were deposited on dielectric surfaces of the convoluted, interconnected open pore structure. The anode was then dried in an oven at 100° C., washed in deionized water and dried.

After EPD impregnation of the anode with conductive polymer, outer coatings of conductive carbon and silver were applied using the same process described in Example 1, providing electrical contact to the cathode for measurements.

Capacitance of the capacitor was then measured and found to be 1.2 μF. ESR was measured to be 4 ohms. Current leakage with an applied DC voltage of 6.8V was measured to be 0.06 μA.

Although embodiments of the invention have been described by way of illustration, it will be understood that the invention may be carried out with many variations, modifications, and adaptations, without departing from its spirit or exceeding the scope of the claims.

1. A method for forming a conductive polymer cathode for a solid electrolyte capacitor, said method comprising:
(a) immersing the dielectric coated anode body of a solid electrolyte capacitor in an electrophoretic deposition (EPD) cell, said cell containing a dispersion of particles of said conductive polymer in a liquid;
(b) using a power supply to apply a voltage between said anode body and a counter electrode, thereby forming a current that deposits a continuous conductive polymer cathode layer on the free surface of said dielectric.

2. A method according to claim 1, wherein the voltage applied in the EPD cell has a value that is selected from the group comprising:
a) slightly less than the dielectric formation voltage;
b) equal to the dielectric formation voltage; and
c) greater than the dielectric formation voltage.

3. A method according to claim 1, wherein the EPD current is controlled at the power supply.

4. A method according to claim 3, wherein the EPD cell current is held constant.

5. A method according to claim 4, wherein the constant EPD current is in the range of 0.01 mA to 0.5 mA per mg of anode mass.

6. A method according to claim 1, wherein the conductive polymer coats the convoluted dielectric free surface of the pore structure within the solid electrolytic capacitor anode.

7. A method according to claim 1, wherein the outer surface of the dielectric coated anode is coated with conductive polymer during the EPD process of forming the cathode from said conductive polymer on the convoluted dielectric free surface of the pore structure within said solid electrolytic capacitor anode.

8. A method according to claim 1, wherein an EPD process is used to coat with conductive polymer the outer surface of an anode previously impregnated with cathode material.

9. A method according to claim 8, wherein the cathode material comprises a material chosen from the following group:
(a) manganese dioxide;
(b) conductive polymer produced by in situ chemical polymerization; and
(c) conductive polymer deposited with EPD from conductive polymer dispersion.

10. A method according to claim 8, wherein the thickness of the external conductive polymer coating is at least 1 micrometer.

11. A method according to claim 1, wherein the conductive polymer is any conductive polymer material that can be dispersed as particles in a liquid wherein said particles and said dispersion have characteristics that allow EPD to be performed.

12. A method according to claim 11, wherein the conductive polymer material is chosen from the group comprising:
(a) polythiophene or derivatives thereof;
(b) polyaniline or derivatives thereof; and
(c) polypyrole or derivatives thereof.

13. A method according to claim 11, wherein the concentration of the particles in the dispersion is in the range of 1.5% to 10% by weight.

14. A method according to claim 11, wherein the viscosity of the dispersion is in the range of 5 cP to 70 cP.

15. A method according to claim 11, wherein Zeta potential of the dispersion is lower than −30 mV.

16. A method according to claim 11, wherein the pH of the dispersion is in the range of 1 to 3.

17. A method according to claim 1, wherein the dispersion conductivity is greater than 50 S/cm.

18. A method according to claim 6, wherein the mean size of the particles in the dispersion is smaller than the mean pore size within the anode.

19. A method according to claim 8, wherein the mean particle size in the dispersion is smaller than 10 micrometers.

20. A method according to claim 6, wherein the conductive polymer has maximum electrical conductivity, at least higher than 30 S/cm.

21. A method according to claim 8, wherein the conductive polymer has maximum electrical conductivity, at least higher than 50 S/cm.

22. A solid electrolytic capacitor comprising a cathode made from a conductive polymer layer formed by an EPD process on the free surface of the dielectric coating of an anode body.
